(19) United States
(12) Patent Application Publication
(10) Pub. No.: US 2025/0256701 A1
(43) Pub. Date: Aug. 14, 2025

(54) HYBRID VEHICLE

(71) Applicant: TOYOTA JIDOSHA KABUSHIKI KAISHA, Toyota-shi (JP)

(72) Inventor: Yuki YAMADA, Toyota-shi (JP)

(73) Assignee: TOYOTA JIDOSHA KABUSHIKI KAISHA, Toyota-shi (JP)

(21) Appl. No.: 19/051,993

(22) Filed: Feb. 12, 2025

(30) Foreign Application Priority Data
Feb. 14, 2024 (JP) 2024-020352

(51) Int. Cl. B60W 20/40; B60W 50/14

(52) U.S. Cl. CPC B60W 20/40; B60W 50/14; B60W 2050/146

(57) ABSTRACT

The controller of a hybrid vehicle maintains the normal driving mode even if there is a request to switch to the motor driving mode based on the driving support plan until a predetermined time has elapsed when the mode is switched to the normal driving mode by operating the mode selection switch. As a result, the driver's sense of discomfort can be reduced by switching to the motor driving mode within a short time after switching to the normal driving mode by operating the mode selection switch.

### CROSS-REFERENCE TO RELATED APPLICATIONS

The present disclosure claims priority to Japanese Patent Application No. 2024-020352 filed Feb. 14, 2024, which is incorporated herein by reference in its entirety including specification, drawings and claims.

### TECHNICAL FIELD

The present disclosure relates to a hybrid vehicle.

### BACKGROUND

Conventional hybrid vehicles of this type have been proposed that switch between an electric vehicle mode in which the electric motor runs alone, an engine mode in which the engine runs alone, and a combined mode in which both run together according to the mode-switching vehicle speed (see, for example, Patent Document 1). This hybrid vehicle can be driven in an environmentally compatible manner by switching the mode-switching vehicle speed for each environment, such as urban, suburban, highway, tunnel, and so on.

### CITATION LIST

### Patent Document

[Patent Document 1] Japanese Patent Application Laid Open No. H06-187595

### SUMMARY

In such hybrid vehicles, there is a mode selection switch that switches between a motor driving mode, in which the vehicle is driven by power from the motor with the engine stopped, and a normal driving mode, in which the vehicle is driven by power from the engine and the motor as necessary, the driver can freely choose between driving in the motor driving mode and driving in the normal driving mode by operating the mode selection switch. In addition, a driving support plan has been proposed that assigns the motor driving mode and the normal driving mode to each driving section of the driving route in order to drive the set or estimated driving route in an energy-efficient manner, and a hybrid vehicle that switches the driving mode based on this driving support plan has also been proposed. When the vehicle is travelling in the motor driving mode and the driver switches to the normal driving mode using the mode selection switch, and then switches back to the motor driving mode using the driving support plan or something similar within a short period of time, the driver may feel a sense of discomfort because the driver's intention is not reflected in the switch operation. In addition, when the driver switches to the motor driving mode by operating the mode selection switch on the vehicle, if the motor driving mode is switched to within a short period of time after the switch to the motor driving mode is rejected, the driver will feel uncomfortable about the switch to the motor driving mode despite the rejection of the switch to the motor driving mode. The same also applies when the motor driving mode is cancelled while driving in the motor driving mode, and then switched back to the motor driving mode within a short period of time due to the driving support plan, etc.

The main purpose of the hybrid vehicle described in this disclosure is to reduce the sense of discomfort that drivers experience when switching between driving modes.

The hybrid vehicle of the present disclosure has adopted the following measures to achieve the main objectives described above.

The first hybrid vehicle of the present disclosure comprises:
an engine capable of outputting power for driving;
a motor capable of outputting power for driving;
a power storage device capable of exchanging electric power with the motor;
a mode selection switch that switches between a motor driving mode, in which the vehicle is driven by the power from the motor while the engine is stopped, and a normal driving mode, in which the vehicle is driven by the power from the engine and the power from the motor as necessary;
a controller configured to create a driving support plan that assigns the motor driving mode and the normal driving mode to each driving section of the set or estimated driving route, and executes driving support control that controls the engine and the motor such that they drive based on the driving support plan;
wherein the controller maintains the normal driving mode even if there is a request to switch to the motor driving mode based on the driving support plan until a predetermined time has elapsed when the controller switches the motor driving mode to the normal driving mode by operating the mode selection switch.

The first hybrid vehicle disclosed in this document is equipped an engine capable of outputting power for driving, a motor capable of outputting power for driving, a power storage device capable of exchanging electric power with the motor, a mode selection switch that switches between a motor driving mode, in which the vehicle is driven by the power from the motor while the engine is stopped, and a normal driving mode, in which the vehicle is driven by the power from the engine and the power from the motor as necessary, a controller configured to create a driving support plan that assigns the motor driving mode and the normal driving mode to each driving section of the set or estimated driving route, and executes driving support control that controls the engine and the motor such that they drive based on the driving support plan. The controller maintains the normal driving mode even if there is a request to switch to the motor driving mode based on the driving support plan until a predetermined time has elapsed when the normal driving mode is switched to the motor driving mode by operating the mode selection switch. This reduces the driver's sense of discomfort when the mode selection switch is used to switch to the motor driving mode within a short time after switching to the normal driving mode.

The second hybrid vehicle of the present disclosure comprises:
an engine capable of outputting power for driving;
a motor capable of outputting power for driving;
a power storage device capable of exchanging electric power with the motor;
a mode selection switch that switches between a motor driving mode, in which the vehicle is driven by the power from the motor while the engine is stopped, and a normal driving mode, in which the vehicle is driven by the power from the engine and the power from the motor as necessary;
a controller configured to create a driving support plan that assigns the motor driving mode and the normal driving mode to each driving section of the set or estimated driving route, and executes driving support control that controls the engine and the motor such that they drive based on the driving support plan;
wherein the controller maintains the normal driving mode even if there is a request to switch to the motor driving mode based on the driving support plan until the first predetermined time has elapsed, where the switch to the motor driving mode is rejected when the motor driving mode is switched to by operating the mode selection switch, or where the motor driving mode is cancelled while driving in the motor driving mode.

The second hybrid vehicle disclosed in this document is equipped an engine capable of outputting power for driving, a motor capable of outputting power for driving, a power storage device capable of exchanging electric power with the motor, a mode selection switch that switches between a motor driving mode, in which the vehicle is driven by the power from the motor while the engine is stopped, and a normal driving mode, in which the vehicle is driven by the power from the engine and the power from the motor as necessary, a controller configured to create a driving support plan that assigns the motor driving mode and the normal driving mode to each driving section of the set or estimated driving route, and executes driving support control that controls the engine and the motor such that they drive based on the driving support plan. The controller maintains the normal driving mode even if there is a request to switch to the motor driving mode based on the driving support plan until the first predetermined time has elapsed, where the switch to the motor driving mode is rejected when the motor driving mode is switched to by operating the mode selection switch, or where the motor driving mode is cancelled while driving in the motor driving mode. This reduces the driver's sense of discomfort when the motor driving mode is switched to after the motor driving mode has been rejected or cancelled.

### BRIEF DESCRIPTION OF DRAWINGS

FIG. 1 shows a block diagram of the hybrid vehicle 20 as one embodiment of the present disclosure, with the hybrid ECU 50 shown as a central block.

FIG. 2 shows a flowchart of an example of driving support control executed by the hybrid ECU 50.

FIG. 3 shows a flowchart of an example of the driving support control for a variant.

FIG. 4 shows a flowchart of an example of the driving support control for a variant.

### DESCRIPTION OF EMBODIMENTS

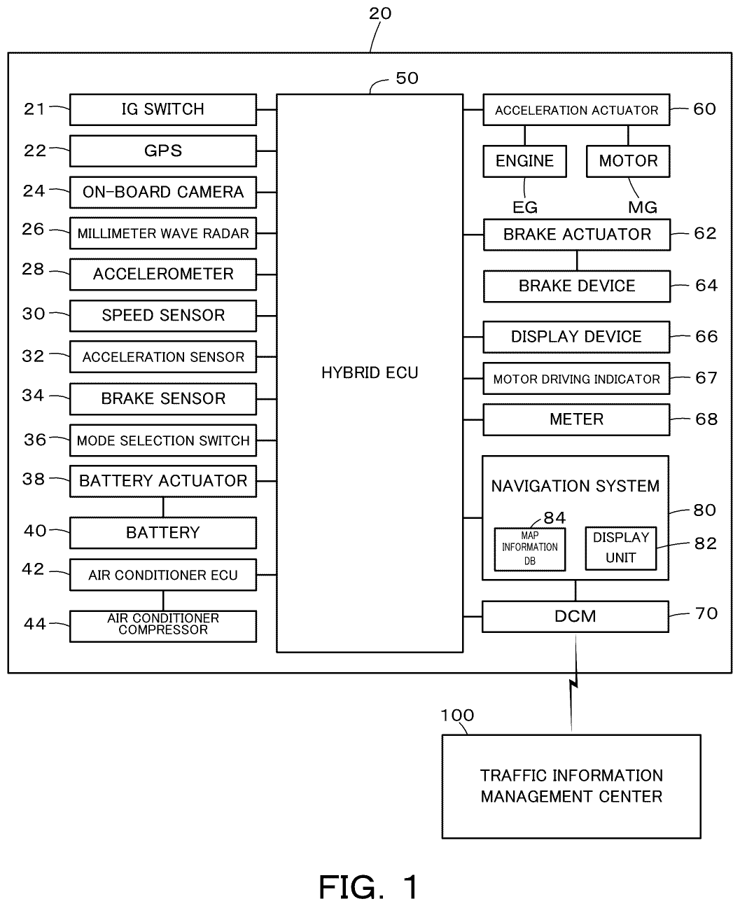

The following is a description of the embodiment of this disclosure. FIG. 1 shows a block diagram of the hybrid vehicle 20 as one embodiment of the present disclosure, showing the hybrid electronic control unit 50 (hereinafter referred to as hybrid ECU 50). as a block at the center. The hybrid vehicle 20 of the embodiment is equipped with the engine EG and the motor MG as a power source, as shown in the figure. The hybrid vehicle 20 of the embodiment has two driving modes: the motor driving mode in which the vehicle is driven by the power from the motor MG with the engine EG operation stopped, and the normal driving mode in which the vehicle is driven by the power from the engine EG and the power from the motor MG, operating the engine EG as necessary.

The hybrid vehicle 20 of the embodiment is equipped with in addition to a power source, the ignition switch 21, GPS (Global Positioning System, Global Positioning Satellite) 22, the on-board camera 24, the millimeter wave radar 26, the accelerometer 28, the vehicle speed sensor 30, the acceleration sensor 32, the brake sensor 34, the mode selection switch 36, the battery actuator 38, the battery 40, the electronic control unit for air conditioners (hereinafter referred to as “air conditioner ECU”) 42, the air conditioner compressor 44, the hybrid ECU 50, the acceleration actuator 60, the brake actuator 62, the brake device 64, the display device 66, the motor driving indicator 67, the meter 68, the DCM (Data Communication Module) 70, the navigation system 80.

GPS22 is a device that detects the position of a vehicle based on signals transmitted from multiple GPS satellites. The on-board camera 24 is the camera that captures images of the vehicle's surroundings, such as a front camera that captures images of the front of the vehicle and a rear camera that captures images of the rear of the vehicle. The millimeter wave radar 26 detects the distance and relative speed between the vehicle and the vehicle in front of it or between the vehicle and the vehicle behind it.

The accelerometer 28 is, for example, a sensor that detects acceleration in the front-back direction of the vehicle or in the left-right (lateral) direction of the vehicle. The speed sensor 30 detects the vehicle speed of the vehicle based on wheel speed and other factors. The acceleration sensor 32 detects the acceleration opening degree, etc., according to the amount of the acceleration pedal depressed by the driver. The brake sensor 34 detects the brake position etc. as the amount the driver depresses the brake pedal. The mode selection switch 36 is located near the steering wheel in the driver's seat and is used to switch between the motor driving mode and the normal driving mode. Basically, when the mode selection switch 36 is operated in the motor driving mode, it switches to the normal driving mode, and when the mode selection switch 36 is operated in the normal driving mode, it switches to the motor driving mode.

The battery actuator 38 detects the state of the battery 40, e for example, the voltage between terminals, the charging and discharging currents, and the battery temperature, and manages the battery 40 based on these. The battery actuator 38 calculates the storage ratio SOC as the ratio of the remaining storage capacity to the total storage capacity based on the charge/discharge current. The battery actuator 38 calculates the maximum allowable output power (the output limit Wout) that may be output from the battery 40 and the maximum allowable input power (the input limit Win) that may be input to the battery 40 based on the storage ratio SOC and the battery temperature. The battery 40 is configured as a rechargeable battery that can be charged and discharged, for example, a lithium-ion battery, a nickel-metal hydride battery, or a lead-acid battery.

The air conditioner ECU 42 is configured as a microcomputer centered on a CPU, which is not shown in the figure, and is equipped with ROM, RAM, the flash memory, the input port, the output port, and the communication port, etc. in addition to the CPU. The air conditioner ECU 42 is incorporated in the air conditioning unit that air-conditions the passenger compartment, and drives and controls the air conditioner compressor 44 in the air conditioning unit such that the temperature in the passenger compartment becomes the set temperature.

The engine EG is configured, for example, as an internal combustion engine. The motor MG is configured as the electric motor that also functions as the generator, for example, the synchronous starting electric motor. The motor MG is connected to the battery 40 via an inverter, not shown in the figure, and can output driving power using the power supplied by the battery 40 or charge the battery 40 with the generated power.

The hybrid ECU 50, which is not shown in the figure, is configured as a microcomputer with a CPU at its core, and is equipped with ROM, RAM, the flash memory, the input port, the output port, and the communication port, etc., in addition to the CPU. The hybrid ECU 50 sets the driving mode and also sets the target operating point (the target rotation speed and the target torque) of the engine EG and the torque command of the motor MG based on the set driving mode, the acceleration opening degree from the acceleration sensor 32, the brake position from the brake sensor 34, and the output limit and input limit from the battery actuator 38. The hybrid ECU 50 does not start with accessory on, but with ready on.

The hybrid ECU 50 sets the required driving force and the required power based on the acceleration opening degree from the accelerometer 28 and the vehicle speed from the speed sensor 30 when the vehicle is running on the motor. So, the hybrid ECU 50 sets the torque command of the motor MG to output the required driving force and the required power to the vehicle, and transmits the set torque command to the acceleration actuator 60. The hybrid ECU 50 sets the target operating point of the engine EG and the torque command of the motor MG to output the required driving force and the required power to the vehicle when hybrid driving, and transmits the target operating point and the torque command to the acceleration actuator 60. The hybrid ECU 50 also sets the required braking force based on the brake position from the brake sensor 34 and the vehicle speed from the speed sensor 30 when the brake pedal is depressed. The hybrid ECU 50 also sets the torque command for regenerative control of the motor MG based on the required braking force and the vehicle speed, and also sets the target braking force by the brake device. The hybrid ECU 50 then transmits the torque command to the acceleration actuator 60 and the target braking force to the brake actuator 62.

The acceleration actuator 60 drives and controls the engine EG and the motor MG according to the target operating point and the torque command set by the hybrid ECU 50. The acceleration actuator 60 performs the intake air volume control, the fuel injection control, the ignition control, and the intake valve open/close timing control such that the engine EG is operated at the target operating point (the target rotation speed and the target torque). The acceleration actuator 60 also controls the switching of the switching elements of the inverter to drive the motor MG such that the torque corresponding to the torque command is output from the motor MG.

The brake actuator 62 controls the brake device 64 such that the target braking force set by the hybrid ECU 50 is applied to the vehicle by the brake device 64. The brake device 64 is configured as the hydraulically driven friction brake, for example.

The display device 66 is built into the installation panel in front of the driver's seat, for example, and displays various information and also functions as a touch panel. The motor driving indicator 67, which is not shown, is built into the installation panel in front of the driver's seat, and lights up when the motor is running and goes out when the motor is not running.

The DCM (Data Communication Module) 70 transmits the vehicle information to the traffic information management center 100 and receives the road traffic information from the traffic information management center 100. The vehicle information can include, for example, the vehicle's position, the vehicle's speed, the driving power, the driving mode, and so on. The road traffic information can include, for example, the information on current and future traffic congestion, the information on the current average vehicle speed and predicted future average vehicle speed in the section on the travel route, the information on traffic regulations, the information on weather, the information on road surface conditions, and the information on maps. The DCM 70 communicates with the traffic information management center 100 at predetermined intervals (e.g., every 30 seconds, 1 minute, 2 minutes, etc.).

The navigation system 80 is the system that guides the vehicle to the set target destination, and is equipped with the display unit 82 and the map information database 84. The display unit 82 is a functional block that has the function of displaying the route to the target destination, the vehicle's position, and other information on the display device 66 based on map information. The navigation system 80 communicates with the traffic information management center 100 via the DCM 70. The navigation system 80 sets the route based on the information of the target destination or the transit destination, the information of the current location (the current position of the own vehicle) obtained by the GPS 22, and the information stored in the map information database 84, when the target destination or the transit destination is set. The navigation system 80 communicates with the traffic information management center 100 at predetermined intervals (e.g., every 3 or 5 minutes) to obtain the road traffic information, and provides the route guidance based on the road traffic information. The map information stored in the map information database 84 includes not only data as the map, but also the road grade, the road type, and the elevation for each driving segment.

The navigation system 80, when providing the route guidance, generates the predictive information such as the load information necessary for traveling each travel segment every time it acquires the road traffic information from the traffic information management center 100 (or every predetermined time) based on the information on each travel segment in the travel route in the road traffic information acquired from the traffic information management center 100, the information on the driving load, the vehicle speed of the own vehicle, the driving power of the own vehicle, the driving mode of the own vehicle, etc., and transmits the information to the hybrid ECU 50. The predictive information includes the information about the vehicle, such as the current position, the vehicle speed, the driving power, the driving mode, and so on, the Information about current and future traffic jams, the information about the current average vehicle speed and predicted average vehicle speed in the future along the travel route, the Information about the traffic restrictions, the information on weather conditions, the information about the road surface condition, the information about maps. The information on the map includes areas that should be driven by the motor (the motor driving area), which are defined by the municipality and other factors. The navigation system 80 can also set the motor driving area by specifying an area, such as an area near the home, through user operation. The navigation system 80 sends a signal to the hybrid ECU 50 to determine whether or not the vehicle is in the motor driving area when driving.

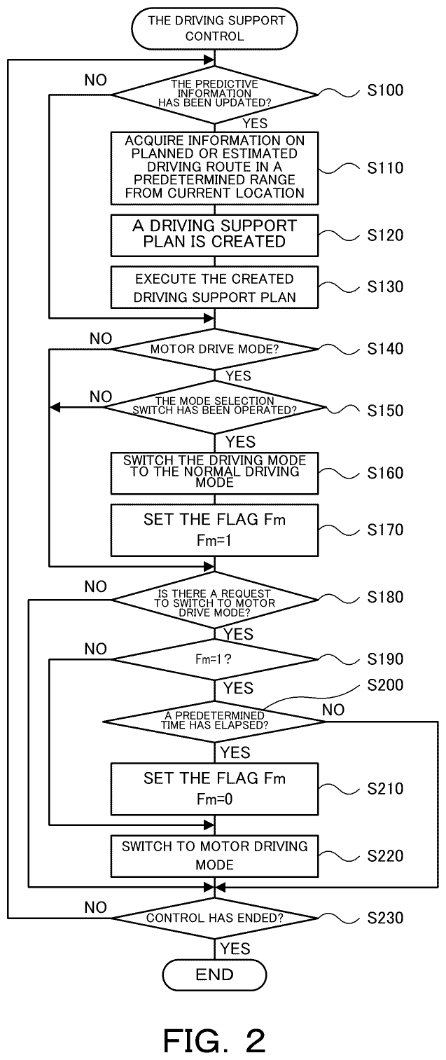

The next section describes the operation of the hybrid vehicle 20 configured in this way, in particular the operation when driving with driving support control. FIG. 2 shows a flowchart of an example of driving support control executed by the hybrid ECU 50. This control is executed from when the ignition switch 21 is turned on and the system is started until the end processing is performed.

When the driving support control is executed, the hybrid ECU 50 first determines whether the predictive information has been updated (step S100). In the embodiment, the determination of whether the predictive information has been updated is performed by determining whether an update signal has been received from the navigation system 80 when the predictive information is generated by the navigation system 80. When it is determined that the predictive information has been updated, information on the planned or estimated driving route within a predetermined range from the current location is acquired (step S110). The predetermined range can be 5 km, 10 km, 15 km, etc. The planned driving route is the driving route planned by the navigation system 80 as route guidance from the current location to the destination by setting the destination, and the estimated driving route is the driving route that is estimated to be traveled from the current location. The information to be acquired includes, in addition to the predictive information described above, the existence of a motor driving area, and if a motor driving area exists, the start and end points of the motor driving area. Then, a driving support plan is created that assigns motor drive mode or normal drive mode to each driving section of the driving route based on the driving route information (step S120), and the created driving support plan is started (step S130). A driving support plan can be created as follows, for example. First, the motor drive mode is assigned to the driving sections of the driving route that fall within the motor drive area. Next, for the driving sections that do not fall within the motor drive area, the motor drive mode is assigned in order of the driving section load, until the storage ratio SOC of the battery 40 reaches the predetermined stored electricity ratio. Then, the normal drive mode is assigned to the remaining driving sections.

The hybrid ECU 50 determines whether the vehicle is being driven in motor drive mode (step S140) when it determines in step S100 that the predictive information has not been updated, or after performing the processing from step S100 to S130. The hybrid ECU 50 determines whether the mode selection switch 36 has been operated by the driver (step S150) when it has determined that the vehicle is being driven in motor drive mode. The hybrid ECU 50 switches the driving mode to the normal driving mode (step S160) and sets the flag Fm to 1 (step S170) when it determines that the mode selection switch 36 has been operated by the driver, that is, when it determines that the mode selection switch 36 has been operated by the driver while driving in the motor driving mode. The initial value of the flag Fm is 0, and when the mode selection switch 36 is operated by the driver to switch to the normal driving mode, the value 1 is set, and it is set to the value 0 in the step S210 described later.

Next, the hybrid ECU 50 determines whether or not there is a request to switch to motor drive mode based on the driving support plan (step S180). The request to switch to motor drive mode is made when driving in normal drive mode and driving through a section of road where motor drive mode is assigned. When the hybrid ECU 50 determines that there is a request to switch to motor drive mode, it determines whether or not the flag Fm has a value of 1 (step S190), and when it determines that the flag Fm has a value of 1, it determines whether or not a predetermined time has elapsed since the mode selection switch 36 was operated by the driver to switch to the normal driving mode (when the flag Fm was set to 1) (step S200). The predetermined time is a time that the driver does not feel too much of a difference when the mode is switched from motor drive mode to normal drive mode and then back to motor drive mode again by operating the mode selection switch 36, and can be set to a time such as 5 seconds, 10 seconds, or 15 seconds. When the Hybrid ECU 50 determines that the predetermined time has elapsed in Step S200, it sets the value 0 to the flag Fm (Step S210), switches the driving mode to motor driving mode (Step S220), and determines whether or not control has ended (Step S230). The determination of whether or not control has ended is made when the destination is reached or when the ignition switch 21 is turned off. When the hybrid ECU 50 determines that control has not ended, it returns to the process of determining whether or not the predictive information in step S100 has been updated, and when it determines that control has ended, it ends the driving support control.

When the hybrid ECU 50 determines that a predetermined time has not elapsed since the mode selection switch 36 was operated by the driver in the step S200 to switch to the normal driving mode (when the flag Fm is set to 1), it determines whether or not the control has ended without switching the driving mode to the motor driving mode and retains the normal driving mode (step S230). On the other hand, if it is determined that the control has not ended, it returns to step S100, and if it is determined that the control has ended, the driving support control is ended. That is, the normal driving mode is maintained without switching to the motor driving mode until a predetermined time has elapsed from the time the mode selection switch 36 is operated by the driver to switch to the normal driving mode (when the flag Fm is set to 1). As a result, the driver can be relieved of any discomfort caused by the mode selection switch 36 being operated by the driver to switch to the normal driving mode and then being switched to the motor driving mode within a short period of time.

When the hybrid ECU 50 determines that the flag Fm is not equal to 1 (it is equal to 0) in step S190, it immediately switches the driving mode from the normal driving mode to the motor driving mode (step S220), and then determines whether or not the control has ended (step S230). Then, if it is determined that the control has not ended, it returns to step S100, and if it is determined that the control has ended, it ends the driving support control.

When the Hybrid ECU 50 determines that there is no request to switch to motor drive mode in Step S180, it retains the current driving mode and determines whether or not control should end (Step S230). Then, if it determines that control should not end, it returns to Step S100, and if it determines that control should end, it ends the driving support control.

When the Hybrid ECU 50 determines that the vehicle is not being driven in motor drive mode (it is being driven in normal drive mode) in Step S140, or when it determines that the vehicle is being driven in motor drive mode in Step S140 but that the driver has not operated the mode selection switch 36 in Step S150, it retains the drive mode and carries out the processing from Step S180 onwards.

In the hybrid vehicle 20 described above, when the mode selection switch 36 is operated by the driver while the vehicle is running in motor drive mode to switch to normal drive mode, the normal drive mode is maintained even if the motor drive mode is requested based on the driving support plan until a predetermined time has elapsed. This reduces the sense of discomfort experienced by the driver when the mode selection switch 36 is operated by the driver to switch to normal driving mode and then switched to motor driving mode within a short period of time.

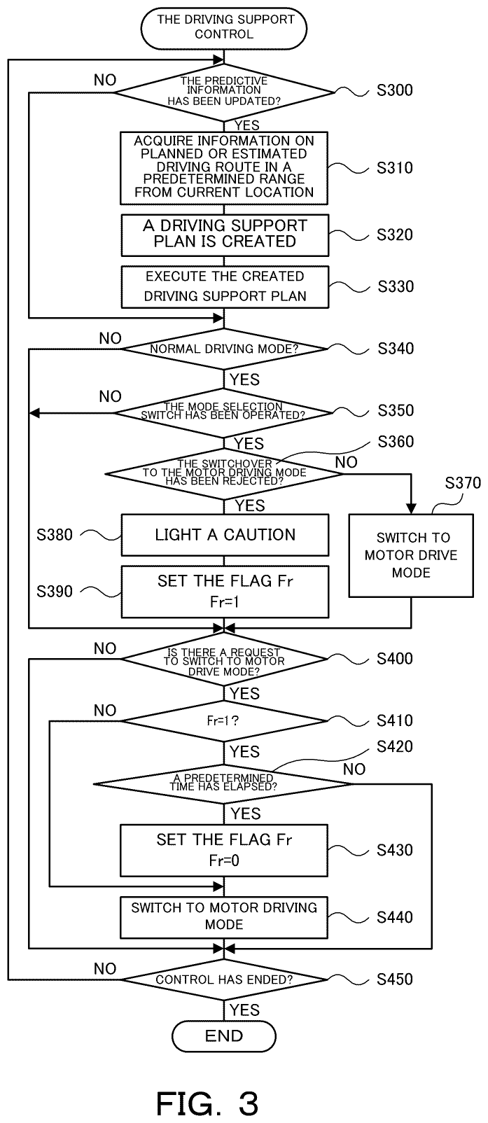

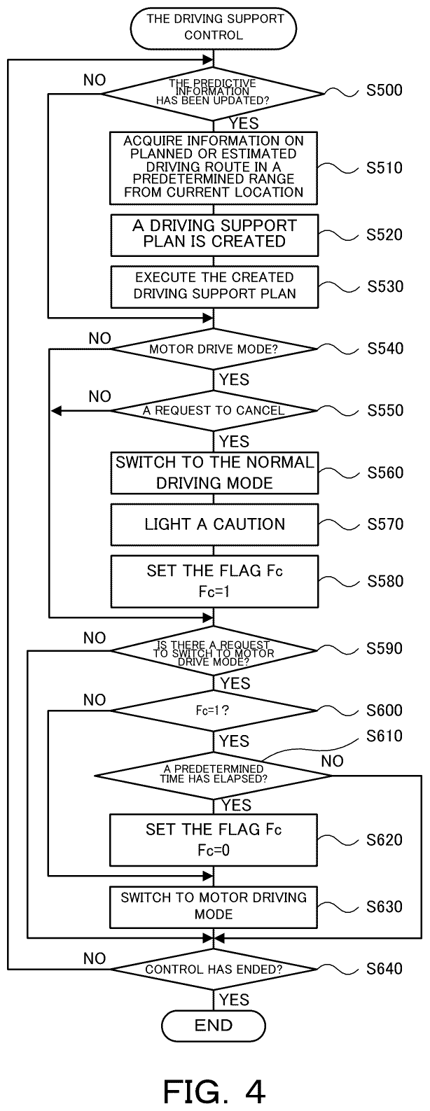

In the embodiment of the hybrid vehicle 20, when the mode selection switch 36 is operated by the driver while driving in motor drive mode to switch to normal drive mode, normal drive mode is maintained until a predetermined time has elapsed. However, it may also be the case that the normal driving mode is maintained until the predetermined time has elapsed even when the driver attempts to switch the driving mode to the motor driving mode by operating the mode selection switch 36 while driving in the normal driving mode, but the system refuses to switch to the motor driving mode for its own reasons. Also, when the motor drive mode is cancelled and the normal drive mode is switched to while driving in the motor drive mode, the normal drive mode may be maintained until the predetermined time has elapsed. An example of driving support control when the switch to the motor drive mode is rejected is shown in FIG. 3, and an example of driving support control when the motor drive mode is cancelled is shown in FIG. 4. The following will be explained in order.

In the driving support control shown in FIG. 3, in the same way as steps S100 to S130 of the driving support control shown in FIG. 2, when the predictive information is updated (step S300), obtain information on the planned or estimated driving route within a predetermined range from the current location (Step S310), create a driving support plan that assigns motor drive mode or normal drive mode to each driving section of the driving route based on the driving route information (Step S320), and start executing the created driving support plan (Step S330).

Next, the hybrid ECU 50 determines whether the vehicle is being driven in normal driving mode (step S340). When the hybrid ECU 50 determines that the vehicle is being driven in normal driving mode, it determines whether the mode selection switch 36 has been operated by the driver (step S350). When the hybrid ECU 50 determines that the mode selection switch 36 has been operated by the driver, that is, when it determines that the mode selection switch 36 has been operated by the driver while driving in the normal driving mode, it determines whether or not the switchover to the motor driving mode has been rejected (step S360). The rejection of the switch to motor drive mode is due to an event that makes it difficult to drive using the motor drive mode, and the following events can be cited as examples, the catalyst is warming up, the state of charge (SOC) of the battery 40 is below a specified value, the temperature of the battery 40 is low, the vehicle speed Vis above a specified speed, and the accelerator opening angle Acc is above a specified angle. When the Hybrid ECU 50 determines that the driver has rejected the switch to motor drive mode, it will light a caution to inform the driver that the switch to motor drive mode has been rejected (step S380), and set the flag Fr to 1 (step S390). The caution light is set to turn on for a shorter time than the predetermined time (step S420) described below. The flag Fr has an initial value of 0, and when the driver rejects the mode selection switch 36 operation to switch to the motor drive mode, the value 1 is set, and it is set to 0 in the step S430 described below. When the hybrid ECU 50 determines that the switch to motor drive mode has not been rejected in step S360, it switches the drive mode from normal drive mode to motor drive mode (step S370).

Next, the hybrid ECU 50 determines whether or not there is a request to switch to motor drive mode based on the driving support plan (step S400). When the hybrid ECU 50 determines that there is a request to switch to motor drive mode, it determines whether or not the flag Fr has a value of 1 (step S410). When the flag Fr is determined to have a value of 1, it determines whether or not a predetermined time has elapsed since the driver's operation of the mode selection switch 36 to switch to motor drive mode was rejected (step S420). The predetermined time is a time long enough for the driver not to feel too much of a difference when the motor drive mode is switched to the motor drive mode by the driving support control after the switch to the motor drive mode is rejected, and is longer than the time for the caution lamp to light up in Step S380. The predetermined time can be 5, 10, or 15 seconds, for example. When the Hybrid ECU 50 determines that the predetermined time has elapsed in Step S420, it sets the flag Fr to 0 (Step S430), switches the driving mode from normal driving mode to motor driving mode (Step S440), and determines whether or not control has ended (Step S450). When it is determined that the control is not over, it returns to step S300, and when it is determined that the control is over, the driving support control is ended.

In this way, when the driver operates the mode selection switch 36 to switch to motor drive mode while driving in normal drive mode, but the system refuses to switch to motor drive mode, the system will maintain normal drive mode even if motor drive mode is requested based on the driving support plan until the predetermined time has elapsed. As a result, the discomfort caused to the driver by the system switching to motor drive mode within a short time after the driver has switched to motor drive mode based on operation of the mode selection switch 36 can be reduced. In addition, when the system refuses to switch to motor drive mode, a caution is lit to inform the driver that the system has refused to switch to motor drive mode. In this case, because the predetermined time is set to be longer than the time the caution is lit, the caution that notifies the driver that the switch to motor drive mode has been rejected will remain lit for a certain period of time before the switch to motor drive mode is made in response to a request for motor drive mode based on the driving support plan. In this way, the sense of discomfort experienced by the driver can be reduced even further.

In the driving support control shown in FIG. 4, in the same way as steps S100 to S130 of the driving support control shown in FIG. 2, when the predictive information is updated (step S500), the hybrid ECU 50 obtains information on the planned or estimated driving route within a predetermined range from the current location (step S510), creates a driving support plan that assigns motor drive mode or normal drive mode to each driving section of the driving route based on the driving route information (step S520), and starts executing the created driving support plan (step S530).

Next, the hybrid ECU 50 determines whether the vehicle is driving in motor drive mode (step S540). When it is determined that the vehicle is driving in motor drive mode, it is determined whether there is a request to cancel the motor drive mode (step S550). The request to cancel the motor drive mode is made due to an event that makes it difficult to continue the motor drive mode, for example, when the state of charge (SOC) of the battery 40 is below a specified value, when the vehicle speed V is above a specified speed, or when the accelerator opening angle Acc is above a specified angle. When it is determined that a request to cancel the motor drive mode has been made, the driving mode is switched from the motor drive mode to the normal driving mode (step S560), a caution is lit to inform the driver that the motor drive mode has been cancelled (step S570), and the flag Fc is set to 1 (step S580). The caution light is set to turn on for a shorter time than the predetermined time (step S610) described below. The flag Fc has an initial value of 0, and is set to 1 when the motor drive mode is cancelled, and is set to 0 in step S620 described below. When it is determined that there is no request to cancel the motor drive mode in step S550, normal driving mode will continue.

Next, the hybrid ECU 50 determines whether or not there is a request to switch to motor drive mode based on the driving support plan (step S590). When it is determined that there is a request to switch to motor drive mode, it is determined whether or not flag Fc has a value of 1 (step S600). Then, when it is determined that flag Fc has a value of 1, it is determined whether or not a predetermined time has elapsed since the motor drive mode was cancelled (step S610). The predetermined time is a time that the driver does not feel too much of a difference when the motor drive mode is switched to the motor drive mode by the driving support control after the motor drive mode is cancelled, and it is a time that is longer than the caution lamp lighting time in step S570. The predetermined time can be 5 seconds, 10 seconds, 15 seconds, etc. for example. When the Hybrid ECU 50 determines that the predetermined time has elapsed in Step S610, it sets the value 0 to the flag Fc (Step S620), switches the driving mode from normal driving mode to motor driving mode (Step S630), and determines whether or not control has ended (Step S640). When it is determined that the control is not finished, it returns to step S500, and when it is determined that the control is finished, the driving support control is terminated.

When the motor drive mode is cancelled while the vehicle is travelling in motor drive mode, the motor drive mode is retained until the predetermined time has elapsed, even if the motor drive mode is requested based on the driving support plan. As a result, the sense of discomfort experienced by the driver when the motor drive mode is switched to within a short time after the motor drive mode is cancelled can be reduced. In addition, when the motor drive mode is cancelled, the caution light comes on, so the driver is notified that the motor drive mode has been cancelled. In this case, because the predetermined time is set to be longer than the time the caution is lit, the switch to motor drive mode based on the driving support plan is carried out after a certain amount of time has passed since the caution lighting to inform the driver that the motor drive mode has been cancelled has finished illuminating. This reduces the sense of discomfort for the driver.

In the hybrid vehicle of the present disclosure, the controller, when the switchover to the motor running mode described above is rejected, may provide notification that the switchover to the motor running mode has been rejected for a second predetermined time that is shorter than the first predetermined time, the controller, when the motor running mode is cancelled, may provide notification that the motor running mode has been cancelled for a second predetermined time that is shorter than the first predetermined time. This way, the driver can be informed of the refusal to switch to the motor driving mode or the cancellation of the motor driving mode.

The following is a description of the correspondence between the main elements of the embodiment and the main elements of the disclosure described in the section on means to solve the problem. In the embodiment, the engine EG corresponds to “the engine”, the motor MG corresponds to “the motor”, the battery 40 corresponds to the “the power storage device”, the mode selection switch 36 corresponds to “the mode selection switch”, and the hybrid electronic control unit 50 corresponds to “the controller”.

The correspondence between the major elements of the embodiment and the major elements of the disclosure described in the means to solve a problem section is an example of how the embodiment can be used to specifically explain the embodiment of the disclosure described in the means to solve a problem section. This does not limit the elements of the disclosure described in the means to solve the problem section. In other words, interpretation of the disclosure described in the means to solve a problem section should be based on the description in that section, and the embodiment is only one specific example of the disclosure described in the means to solve a problem section.

The above is a description of the form for implementing this disclosure using the embodiment. However, the present disclosure is not limited in any way to these embodiments, and can of course be implemented in various forms within the scope that does not depart from the gist of the present disclosure.

### INDUSTRIAL APPLICABILITY

This disclosure can be used in the hybrid vehicle manufacturing industry, for example.

1. A hybrid vehicle comprising:
an engine capable of outputting power for driving;
a motor capable of outputting power for driving;
a power storage device capable of exchanging electric power with the motor;
a power storage device capable of exchanging electric power with the motor;
a mode selection switch that switches between a motor driving mode, in which the vehicle is driven by the power from the motor while the engine is stopped, and a normal driving mode, in which the vehicle is driven by the power from the engine and the power from the motor as necessary; and,
a controller configured to create a driving support plan that assigns the motor driving mode and the normal driving mode to each driving section of the set or estimated driving route, and executes driving support control that controls the engine and the motor such that they drive based on the driving support plan;
wherein the controller maintains the normal driving mode even if there is a request to switch to the motor driving mode based on the driving support plan until a predetermined time has elapsed when the controller switches the motor driving mode to the normal driving mode by operating the mode selection switch.

2. A hybrid vehicle comprising:
an engine capable of outputting power for driving;
a motor capable of outputting power for driving;
a power storage device capable of exchanging electric power with the motor;
a mode selection switch that switches between a motor driving mode, in which the vehicle is driven by the power from the motor while the engine is stopped, and a normal driving mode, in which the vehicle is driven by the power from the engine and the power from the motor as necessary; and,
a controller configured to create a driving support plan that assigns the motor driving mode and the normal driving mode to each driving section of the set or estimated driving route, and executes driving support control that controls the engine and the motor such that they drive based on the driving support plan;
wherein the controller maintains the normal driving mode even if there is a request to switch to the motor driving mode based on the driving support plan until the first predetermined time has elapsed, where the switch to the motor driving mode is rejected when the motor driving mode is switched to by operating the mode selection switch, or where the motor driving mode is cancelled while driving in the motor driving mode.

3. The hybrid vehicle according to claim 2,
wherein the controller, when the switchover to the motor running mode is rejected, provides notification that the switchover to the motor running mode has been rejected for a second predetermined time that is shorter than the first predetermined time.

4. The hybrid vehicle according to claim 2,
wherein the controller, when the motor running mode is cancelled, provides notification that the motor running mode has been cancelled for a second predetermined time that is shorter than the first predetermined time.
